(19) United States
(12) Patent Application Publication
(10) Pub. No.: US 2018/0287832 A1
(43) Pub. Date: Oct. 4, 2018

(54) Radio-Frequency Apparatus with Improved Power Consumption and Associated Methods

(71) Applicant: Silicon Laboratories Inc., Austin, TX (US)

(72) Inventors: Yan Zhou, Spicewood, TX (US); Amey Naik, Austin, TX (US); He Gou, Austin, TX (US)

(21) Appl. No.: 15/472,609

(22) Filed: Mar. 29, 2017

(51) Int. Cl. H04L 25/08; H04W 52/02; H04W 52/52

(52) U.S. Cl. CPC H04L 25/08; H04W 4/005; H04W 52/52; H04W 52/0203

(57) ABSTRACT

An apparatus includes an RF receiver. The RF receiver includes digital signal arrival (DSA) circuitry to detect an arrival of a received signal in the RF receiver and to indicate arrival of the received signal. The RF receiver further includes detection circuitry to detect a signal from the received signal, and a controller to control operation of the detection circuitry depending on whether the DSA circuitry indicates the arrival of the received signal.

### TECHNICAL FIELD

The disclosure relates generally to communication apparatus and associated methods. More particularly, the disclosure relates to apparatus for receivers with reduced or improved power consumption, and associated methods.

### BACKGROUND

With the increasing proliferation of wireless technology, such as Wi-Fi, Bluetooth, and mobile or wireless Internet of things (IoT) devices, more devices or systems incorporate radio frequency (RF) circuitry, such as receivers and/or transmitters. To reduce the cost, size, and bill of materials, and to increase the reliability of such devices or systems, various circuits or functions have been integrated into integrated circuits (ICs). For example, ICs typically include receiver and/or transmitter circuitry. A variety of types and circuitry for transmitters and receivers are used. Transmitters send or transmit information via a medium, such as air, using RF signals. Receivers at another point or location receive the RF signals from the medium, and retrieve the information. Typically, transmitters transmit coded data via RF signals. Receivers receive, decode, demodulate, etc. the RF signals to retrieve the data.

Some wireless communication standards define a preamble for a wireless packet, which is a predefined data pattern that a receiver can use to detect and settle its control loops. The control loops may include the Automatic Gain Control (AGC), Automatic Frequency Compensation (AFC), and Bit Clock Recovery (BCR). After the receiver detects the end of the preamble, the receiver is prepared to receive a full packet including payload data. Some receivers use a preamble detector to detect the arrival of a frame. In response to the preamble detector signaling the detection of the preamble, the receiver begins looking for the next portion of the frame. In the In the IEEE 802.15.4 based ZigBee frame protocol, this next portion is a synchronization word (SYNC word). Under certain circumstances, the preamble detector can occasionally provide a false trigger, such as when a co-channel continuous wave (CW) tone is received at around sensitivity of the preamble detector, or when certain noise patterns are received.

The description in this section and any corresponding figure(s) are included as background information materials. The materials in this section should not be considered as an admission that such materials constitute prior art to the present patent application.

### SUMMARY

A variety of apparatus and associated methods are contemplated according to exemplary embodiments. According to one exemplary embodiment, an apparatus includes an RF receiver. The RF receiver includes digital signal arrival (DSA) circuitry to detect an arrival of a received signal in the RF receiver and to indicate arrival of the received signal. The RF receiver further includes detection circuitry to detect a signal from the received signal, and a controller to control operation of the detection circuitry depending on whether the DSA circuitry indicates the arrival of the received signal.

According to another exemplary embodiment, an IC includes an RF receiver. The RF receiver includes DSA circuitry that includes a correlator to operate on a subset of bits of a set of bits comprising a received signal in the RF receiver to reduce a power consumption of the correlator. The DSA circuitry provides a signal indicating arrival of the received signal. The RF receiver further includes a controller to control operation of a detection circuitry depending on whether the DSA circuitry indicates the arrival of the received signal.

According to another exemplary embodiment, a method of processing signals in an RF receiver includes detecting arrival of a signal received in the RF receiver by using DSA circuitry, and to indicate arrival of the received signal. The method further includes selectively detecting a signal from the received signal depending on indication by the DSA circuitry of the arrival of the received signal.

### BRIEF DESCRIPTION OF THE DRAWINGS

The appended drawings illustrate only exemplary embodiments and therefore should not be considered as limiting the scope of the application or the claims. Persons of ordinary skill in the art will appreciate that the disclosed concepts lend themselves to other equally effective embodiments. In the drawings, the same numeral designators used in more than one drawing denote the same, similar, or equivalent functionality, components, or blocks.

FIG. 1 illustrates a circuit arrangement for an RF receiver according to an exemplary embodiment.

FIG. 2 depicts a circuit arrangement for an RF receiver according to another exemplary embodiment.

FIG. 3 shows a circuit arrangement for receive-path circuitry in an RF receiver according to an exemplary embodiment.

FIG. 4 depicts a circuit arrangement for an RF receiver according to an exemplary embodiment.

FIGS. 5-8 illustrate circuit arrangements for controlling operation of detection circuitry according to exemplary embodiments.

FIGS. 9-11 depict process flow diagrams for a method of operating an RF receiver according to an exemplary embodiment.

FIG. 12 illustrates a system for radio communication according to an exemplary embodiment.

FIGS. 13-14 show circuit arrangements for ICs according to exemplary embodiments.

### DETAILED DESCRIPTION

The disclosed concepts relate generally to RF receivers or transceivers. More specifically, the disclosed concepts provide apparatus and methods for RF receivers or transceivers with reduced power consumption, and associated methods, as described below in detail.

In typical RF receivers, such as those employing direct-sequence spread spectrum (DSSS) offset quadrature phase shift keying (OQPSK) demodulators, the detection circuitry (or signal detection circuitry or detector circuit or detection block) consumes relatively large amounts of power within the demodulator circuit and, hence, within the RF receiver. For example, in some cases, detection circuitry in DSSS OQPSK demodulators can consume about one-third of the total demodulator power consumption. The relatively large power consumption arises typically from the correlation operations performed during the signal detection operations that the detection circuitry performs.

In exemplary embodiments, the amount of power consumed is reduced substantially, for example, by 70% in some embodiments, while using less than about 10% additional circuit area (e.g., the area used in an IC because of the additional circuitry). The power consumption reduction operates by turning off (or shutting off or shutting down or inhibiting or putting in a sleep mode) the detection circuitry during preamble searches.

Once a preamble search succeeds or an actual or desired signal arrives, the detection circuitry is turned on (or powered up or put in an active mode or put in a normal mode of operation). Given that in a modem or RF receiver generally time is mostly spent (e.g., 99% in some cases) in a preamble search state, turning off the detection circuitry during preamble search periods provides relatively large power savings.

Exemplary embodiments further provide additional protection against noise-induced false signal detections, as described below in detail. In other words, techniques and circuitry are used to avoid noise-induced false signal detections from blocking incoming packets. (When the demodulator falsely qualifies noise as valid preamble and SYNC word, it starts to demodulate the data. During this process, the RF receiver might miss any real (not noise-induced) incoming packet.)

The disclosed techniques may be used in, or applied to, a variety of RF receivers. In some embodiments, the RF receiver is configured or designed to operate on (e.g., receive, process, etc.) signals conforming to particular protocols or standards. For instance, in some embodiments, the RF receiver is configured to comply with IEEE 802.15.4 standard, sometimes called ZigBee. In other embodiments, RF receivers may comply with other protocols or standards, as desired, and as persons of ordinary skill in the art will understand.

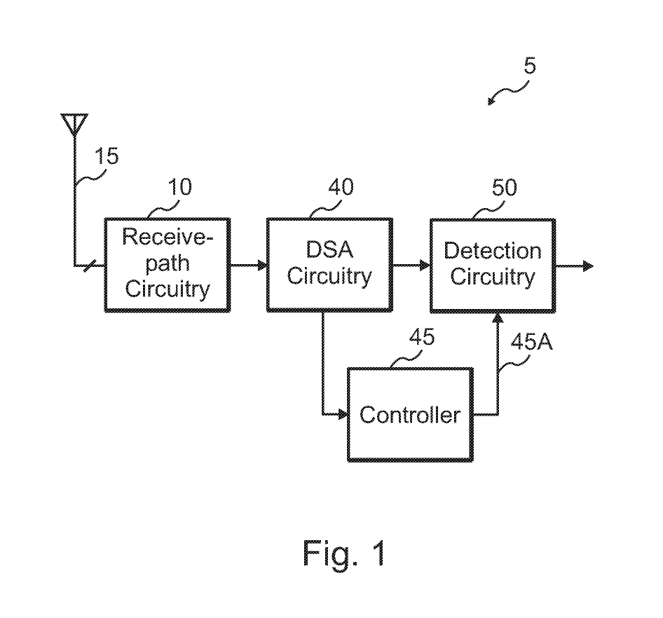

FIG. 1 illustrates a circuit arrangement for an RF receiver 5 according to an exemplary embodiment. An antenna 15 provides RF signals to receive-path circuitry 10. Receive-path circuitry 10 performs various signal processing or conversion operations to generate or derive digital signals from the RF signals, as described below in detail.

Receive-path circuitry 10 provides one or more digital signals derived from received RF signals to digital signal arrival (DSA) circuitry 40 (or DSA detector circuit). As the name suggests, DSA circuitry 40 detects the arrival of a desired RF signal, for example, an RF signal having one or more characteristics, such as specified or desired modulation, etc.

Once signal arrival has been detected, an output of DSA circuitry 40 provides an indication of the signal arrival to controller 45. Among other tasks in the RF receiver, controller 45 controls the operation of detection circuitry 50. For example, in exemplary embodiments, controller 45 can cause detection circuitry 50 to operate in at least two modes of operation.

More specifically, in one mode of operation, detection circuitry 50 operates in a normal or detection or high-power or enabled mode of operation. During this mode of operation, detection circuitry 50 operates on signals provided by DSA circuitry 40 to detect the presence of proper or desired or valid signals, such as packets, frames, etc.

Alternatively, controller 45 can cause detection circuitry 50 to occupy a low-power or powered-down or inhibited or disabled mode. In this mode, detection circuitry 50 consumes less power than in the normal or detection mode of operation. Thus, if there is no signal arrival indication from DSA circuitry 40, controller 45 causes detection circuitry 50 to be powered-down or inhibited or disabled. As a consequence, the power consumption of detection circuitry 50 and, thus, of RF receiver 5, is reduced.

Once DSA circuitry 40 provides to controller 45 a signal arrival indication, controller 45 causes detection circuitry 50 to resume or be placed in the normal or detection or high-power or enabled mode of operation. Consequently, detection circuitry 50 operates on the signals provided by DSA circuitry 40 to perform signal detection, as noted above.

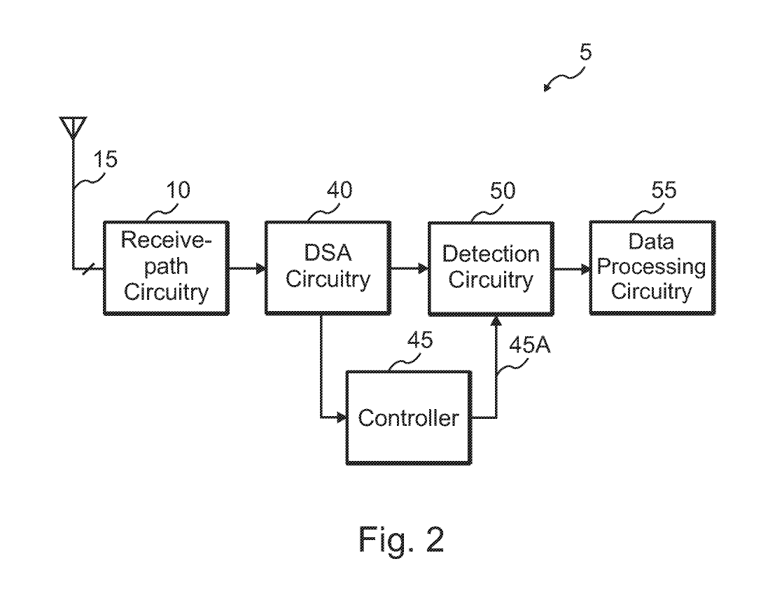

In some embodiments, the RF receiver may include data processing circuitry. FIG. 2 shows such an RF receiver according to an exemplary embodiment. Specifically, RF receiver 5 includes data processing 55. Detection circuitry 50 provides information, such as the demodulated data, to data processing circuitry 55.

Data processing circuitry 55 may perform a variety of functions (e.g., logic, arithmetic, etc.). For example, data processing circuitry 55 may use the demodulated data in a program, routine, or algorithm (whether in software, firmware, hardware, or a combination) to perform desired control or data processing tasks.

In some embodiments, data processing circuitry 55 may perform control of other circuitry, sub-system, or systems (not shown). In some embodiments, data processing circuitry 55 may provide the data (after processing, as desired, for example, filtering) to another circuit (not shown), such as a transducer, display, etc.

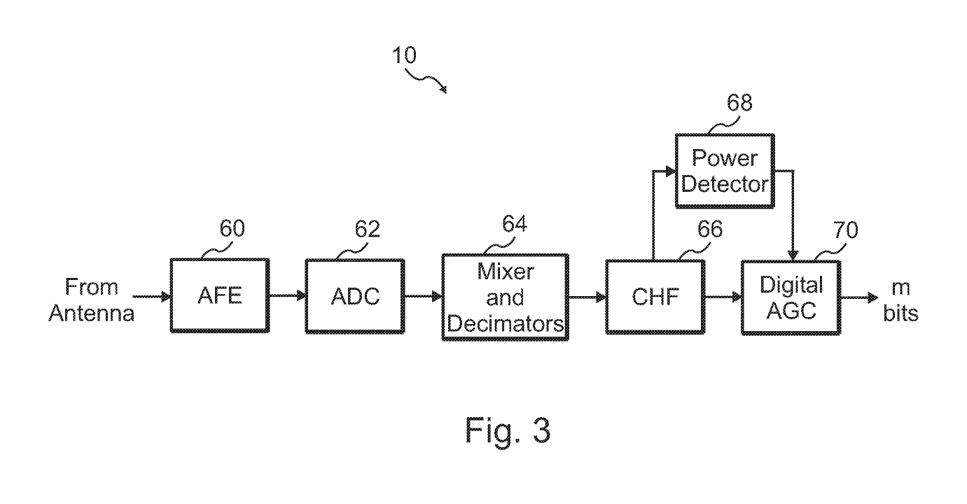

FIG. 3 shows details of receive-path circuitry 10 in an RF receiver according to an exemplary embodiment. Specifically, receive-path circuitry 10 includes analog front-end (AFE) 60, which may include switches, filters, passive networks, and the like (e.g., for different bands of operation of the RF receiver), to interface the RF receiver to antenna 15 (not shown), as persons of ordinary skill in the art will understand.

AFE 60 provides an RF signal to analog to digital converter (ADC) 62. ADC 62 converts the analog RF signal to a digital signal, and provides the digital signal to mixer and decimators 64. Mixer and decimators 64 performs mixing of the digital signal from ADC 62 to generate a baseband or mixed-down signal, and decimation operation(s) on that signal, as persons of ordinary skill in the art will understand. The resulting signal is provided to channel filter (CHF) 66.

CHF 66 performs channel filtering on the signal from mixer and decimators 64. Channel filtering seeks to filter signals outside a desired channel, as persons of ordinary skill in the art will understand. The output of CHF 66 feeds digital automatic gain control (AGC) 70 (or digital AGC circuit 70).

Digital AGC 70 adjusts the level of the signal from CHF 66 and provides the resulting signal as an m-bit output signal. Digital AGC 70 adjusts the signal level based on an input that it receives from power detector 68. Power detector 68 detects the power level of the output signal of CHF 66 (by performing an I²+Q² operation, where I and Q represent the in-phase and quadrature components of the signal, respectively).

In other words, the incoming RF signal is normalized by continuously tracking the power (using power detector 68) of the channel filter (CHF 66) output signal. Power detector 68 averages the power of the output signal of CHF 66 over a desired or prescribed or selected duration to avoid sudden spikes. In some embodiments, the duration may be selected experimentally so as to avoid such spikes in the output signal of digital AGC 70.

Digital AGC 70 is used to selectively choose a number of bits holding the signal information. This operation helps keep the number of bits lower, thus saving hardware resources. More specifically, the power consumption of the correlator (described below in detail) can be reduced by selectively selecting a relatively small number of bits (e.g., m bits) that dominantly carry the signal provided to digital AGC 70 from CHF 66. In other words, a subset of m bits from the total number of bits in the signal are selected. This operation is performed by normalizing the incoming signal by continuously tracking the channel filter power, as described above. Note that the output signals of mixer and decimators 64, CHF 66, and digital AGC 70 are complex signals, and therefore have both I and Q components.

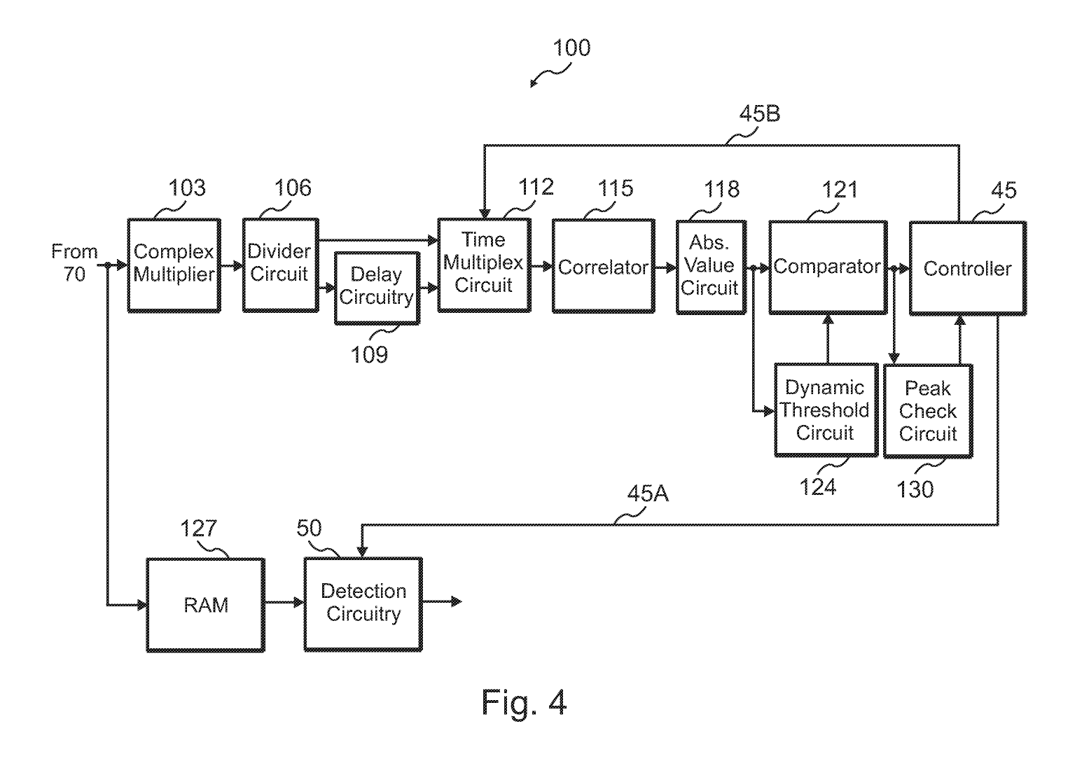

Digital AGC 70 provides m bits of information to circuitry that detects signal arrival, i.e., DSA circuitry 40. FIG. 4 depicts a circuit arrangement 100 that provides details of DSA circuitry 40 according to an exemplary embodiment. Note that FIG. 4 also illustrates detection circuitry 50, coupled to the DSA circuitry. (The DSA circuitry and the detection circuitry are both part of the demodulator circuitry of the RF receiver.)

Referring again to FIG. 4, the output signal of digital AGC 70 feeds the input of complex multiplier 103 and also random access memory (RAM) 127. RAM 127 is used to store incoming signal values such that no preamble is lost due to late detection by the DSA circuitry. Detection circuitry 50 is used to perform signal detection using the values stored in RAM 127.

Complex multiplier 103 acts as a frequency discriminator. In exemplary embodiments, either the I or Q component of the output signal of complex multiplier 103 is used. As noted, the output signal of digital AGC 70 (see FIG. 3) has both I and Q components (i.e., the output signal has the form I+jQ), which are fed to complex multiplier, along with delayed versions of those signals. Complex multiplier 103 provides an output signal given by (I+jQ)×(I_{symbol}_{_}_{delay}−jQ_{symbol}_{_}_{delay}), where I_{symbol}_{_}_{delay} and Q_{symbol}_{_}_{delay} represent the I and Q signals (from digital AGC 70) that have been delayed by a symbol period. The complex components of the output signal of complex multiplier 103 may therefore be written as Iₒᵤₜ=I·I_{symbol}_{_}_{delay}+Q·Q_{symbol}_{_}_{delay}, and Qₒᵤₜ=Q·I_{symbol}_{_}_{delay}·I·Q_{symbol}_{_}_{delay}, respectively.

The quadrature component of the output of complex multiplier 103, i.e., Qₒᵤₜ, feeds the input of divider 106. The bitwidth of Qₒᵤₜ is twice the bitwidth of the input signal (input_bitwidth) minus one, or the quantity 2×input_bitwidth−1. Divider 106 right-shifts the input signal to reduce the bit-width to a smaller number (for example, 3 bits in some embodiments). This operation allows reducing the chip area and power consumption of correlator 115. The division operation, i.e., the number of shifts, may be programmable in some embodiments, for example, by using a value stored in a register or other configuration techniques, as desired.

The output signal of divider 16 is over-sampled by a desired factor, say, OSR, where OSR is greater than unit (OSR>1). Delay circuit 109 provides a sub sampled (by selecting any two equally spaced phases) symbol as an output signal. The Q component of the output signal of divider 106 feeds one input of time multiplex circuit 112, and a delayed version, generated by delay circuit 109, feeds another input of time multiplex circuit 112.

Controller 45 provides select signal 45B to time multiplex circuit 112. Based on the value of select signal 45B, one of the two values corresponding to two phase values (e.g., phase 1 and phase 3) is provided to correlator 115. Use of time multiplex circuit 112 reduces the hardware resources used by sharing those resources (rather than duplicating them). Accordingly, the chip area in an IC that includes the RF receiver and, hence, its cost, are reduced.

Correlator 115, which is part of the DSA circuitry, performs a correlation operation on the input signal it receives from time multiplex circuit 112. For instance, in some embodiments, correlator 115 is used to correlate locally stored 32-bit chips (in case of DSSS OQPSK modulation pursuant to the IEEE 802.15.4 standard, 1 preamble symbol equals 32 chips) over n of p incoming preambles (i.e., over a subset of incoming preambles). Thus, correlator 115 stores n×32 bits, or 32n bits. The 32n bits are correlated with incoming p preambles (i.e., p×32 bits).

Note that the number p is defined by or depends on the type or modulation scheme of the RF signal received or communicated, for example, on an RF communication standard or protocol. The number n (of p available) is chosen such that the RF receiver's sensitivity is not affected adversely (or is not materially affected, for instance, compared to prescribed specifications or desired performance when operating on signals that conform to desired standards or protocols).

Correlator 115 occupies relatively small amounts of chip area and consumes relatively small amounts of power (compared, for example, to detection circuitry 50). The power consumption of correlator 115 is reduced by selectively choosing relatively few (less than all) bits that dominantly carry the signal, indicated as m bits and discussed above.

The number m depends on a number of factors, such design and performance specifications for a given implementation, available technology, cost considerations, etc., as persons of ordinary skill in the art will understand. In some embodiments that employ DSSS OQPSK modulation in accordance with the IEEE 802.15.4 standard, m may be selected to equal 5.

The output of correlator 115 feeds the input of absolute value circuit 118. Absolute value circuit 118 provides as its output the absolute value of its input signal. The output of absolute value circuit 118 feeds the input of comparator 121 and the input of dynamic threshold circuit 124.

Comparator 121 compares the output signal of correlator 115 with a threshold value. Either of abs(out_phase1) or abs(out_phase3) is compared against a threshold in comparator 121, where abs represents the absolute value function performed by absolute value circuit 118, and out_phase1 and out_phase3 represent two phase values of the output signal of correlator 115, for example, phase values 1 and 3 (or phases 1 and 3). If the output signal of correlator 115 exceeds the threshold value, comparator 121 provides a signal to controller 45 that indicates signal arrival (DSA function). In response, controller 45 uses signal 45A to cause detection circuitry 50 to be enabled, powered on, clocked, etc., in order to perform signal detection on the values stored in RAM 127.

The threshold value used by comparator 121 is dynamically adjusted by dynamic threshold circuit 124. Dynamic threshold circuit adjusts the threshold value by estimating noise levels. Noise levels are estimated by averaging the output signal of correlator 115. Using dynamic threshold values improves receiver performance, for example, in the case of elevated noise and blocker signals.

To avoid false detections in elevated noise situations or when blocker signals are present, a peak check circuit 130 is used. Peak check circuit 130 is used to prevent DSA falsely triggered because of noise, blocker, or spurious or undesired signals.

Peak check circuit 130 considers a qualified DSA correlation peak as any peak that exceeds the DSA threshold value. Peak check circuit 130 tracks and keeps the highest correlation peaks. In exemplary embodiments, the number of peaks kept may be programmable or selectable or configurable.

A valid DSA detection occurs when the durations between each of the collected peaks is equal to the preamble symbol duration plus some tolerance value (the tolerance value might be positive or negative). If this condition is not met, a flag (DSA_detected) is reset, and the demodulator circuitry is powered down or disabled or inhibited.

The demodulator circuitry (including the DSA circuitry) is reset (for example, by using controller 45 or other circuitry) when a false DSA detection occurs. This situation occurs if timing (timing state is determined by the demodulator, not by the DSA circuitry) is not detected within p preamble time plus s SYNC word time, where the sum of p and s represents the total number of preambles+SYNC defined for the receiver circuit overall or for the physical layer of the RF receiver (PHY).

The DSA circuitry is gated off or disabled when a frame is detected (frame detection is determined by demodulator's state machine (not shown), which may be included in controller 45, as desired). In another words, the DSA circuitry is disabled or inhibited or powered down or off once a valid SYNC word is detected. Note that a variety of ways may be used to disable or inhibit the DSA circuitry, as described below in connection with detection circuitry 50.

The DSA circuitry consumes comparatively small amounts of power. In comparison, detection circuitry 50 consumes much larger amounts of power (primarily because of the correlation operations) as a fraction of the total amount of power consumed by the demodulator circuitry. For example, detection in DSSS OQPSK demodulator consumes about one-third of the entire power that the demodulator circuitry consumes.

As noted above, RF receivers according to exemplary embodiments control the operation of detection circuitry 50 in order to reduce the power consumption of the RF receiver. The power consumption reduction operates by turning off (or shutting off or shutting down or powering off or powering down or disabling or inhibiting or putting in a sleep mode) the detection circuitry during preamble searches.

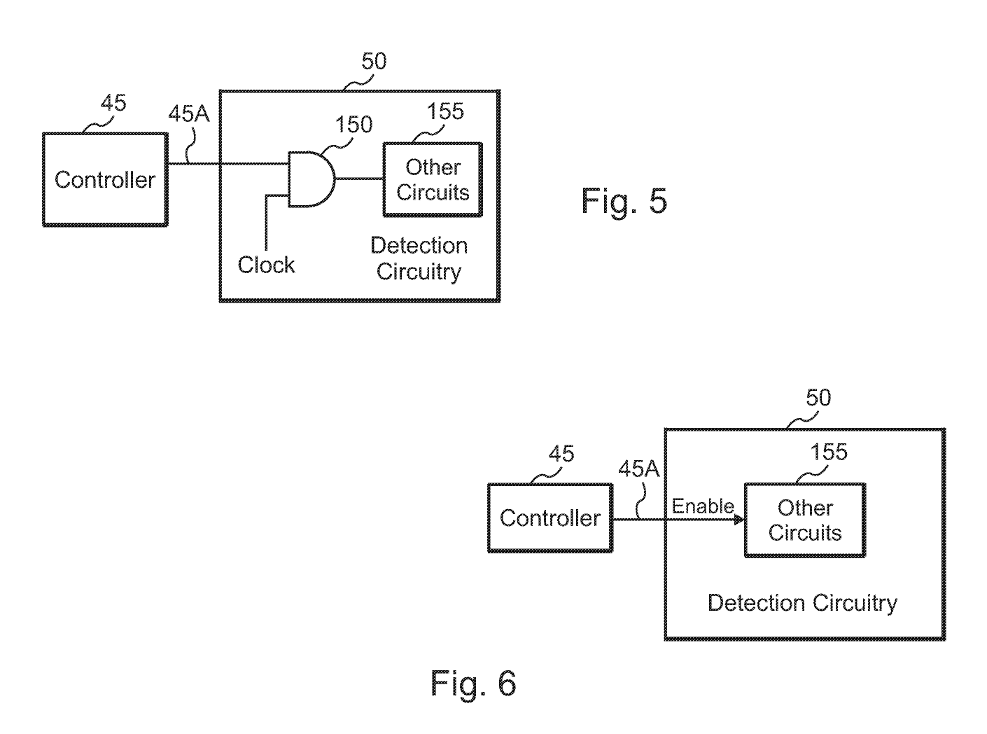

FIGS. 5-8 illustrate circuit arrangements for controlling operation of detection circuitry 50 in RF receivers according to exemplary embodiments. Note that similar techniques may be used to control the operation of the DSA circuitry (e.g., turn off, shut off, shut down, power down, inhibit, put in a sleep mode, disable, etc.).

In the circuit arrangement shown in FIG. 5, controller 45 provides signal 45A to AND gate 150. The clock signal for detection circuitry 50 is applied to another input of AND gate 150. When signal 45A has a binary 0 value, AND gate 150 prohibits the clock signal from being applied to other circuits 155 in detection circuitry 50. Conversely, when signal 45A has a binary 1 value, the clock signal is applied via AND gate 150 to other circuits 155.

In the circuit arrangement shown in FIG. 6, signal 45A from controller 45 serves as an enable signal for other circuits 155. Thus, by controlling the value of signal 45A, controller 45 controls the operation (enabled, disabled) of other circuits 155 in detection circuitry 50.

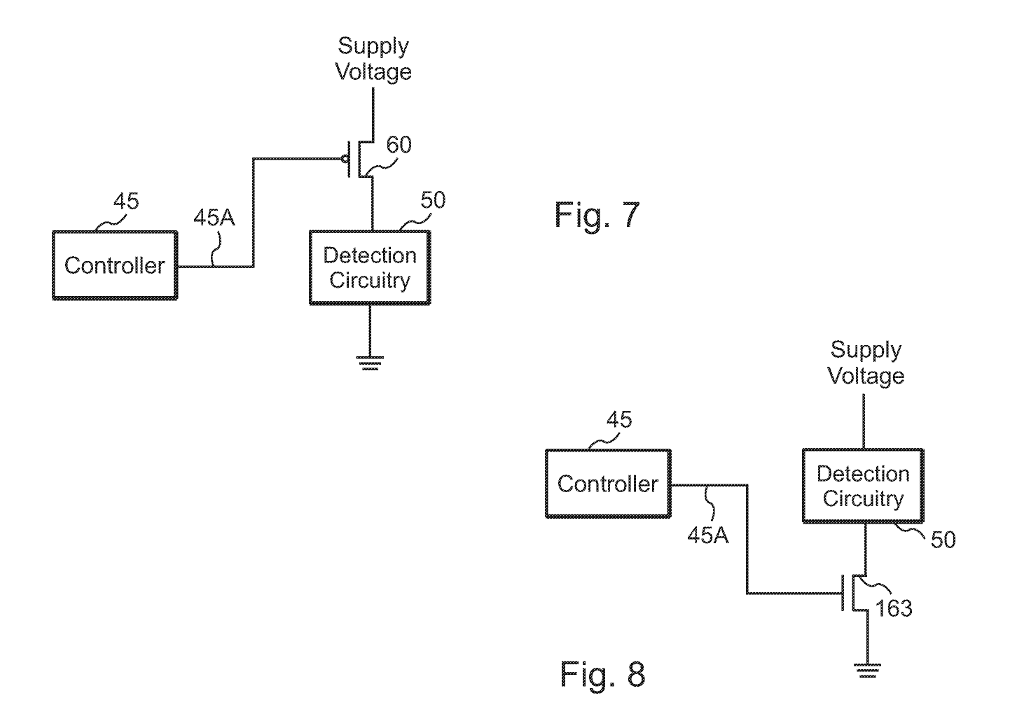

In the circuit arrangement shown in FIG. 7, signal 45A from controller 45 is used to control a switch, which is shown as transistor 160 in the exemplary embodiment depicted. Transistor 160 is coupled between a supply voltage for the RF receiver and the supply terminal or node for detection circuitry 50. When signal 45A has a binary 0 value, transistor 160 turns on, and power is supplied to detection circuitry 50. Conversely, when signal 45A has a binary 1 value, transistor 160 turns off, and power is removed or cut off from detection circuitry 50.

In the circuit arrangement shown in FIG. 8, signal 45A from controller 45 is used to control a switch, which is shown as transistor 163 in the exemplary embodiment depicted. Transistor 163 is coupled between the ground node (power supply ground) of the RF receiver and the ground terminal or node for detection circuitry 50. When signal 45A has a binary 1 value, transistor 163 turns on, and current flows from the supply voltage through detection circuitry 50 to ground via transistor 163. Conversely, when signal 45A has a binary 0 value, transistor 163 turns off, thus interrupting the flow of current through detection circuitry 50.

Note that in some embodiments, the concepts in FIGS. 7 and 8 may be combined, as desired. In other words, both transistor 160 and transistor 163 may be used to control the provision of power to detection circuitry 50. In such a scenario, complementary signals derived from signal 45A control transistor 160 and transistor 163.

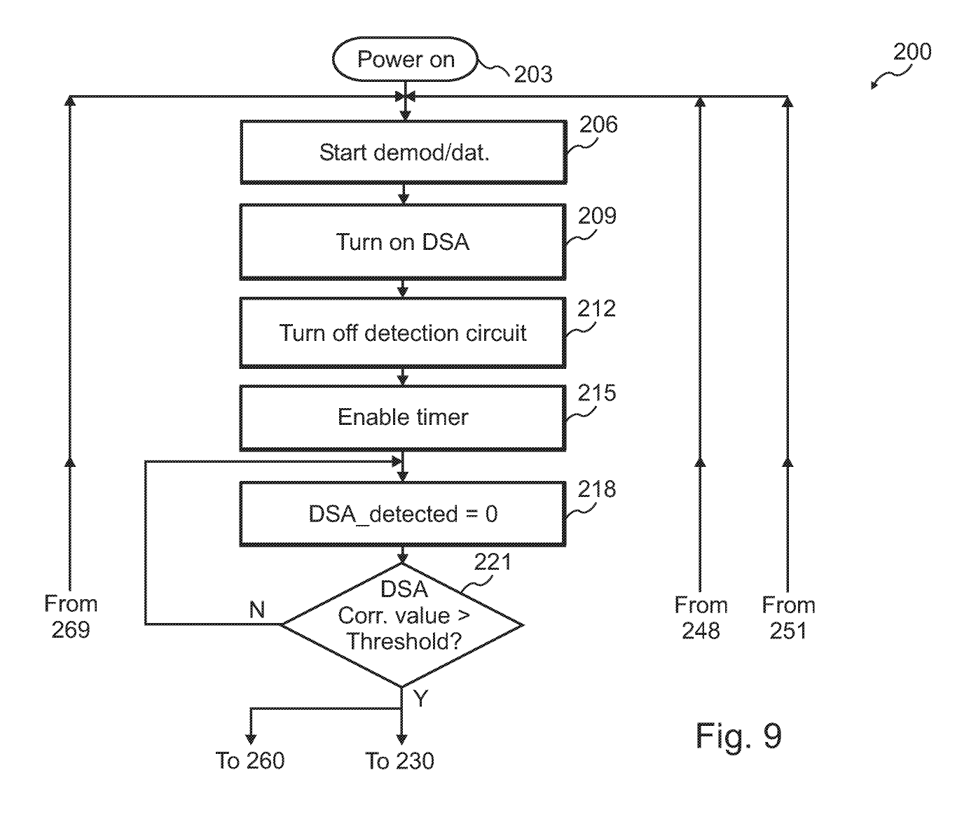

One aspect of the disclosure relates to methods of operating RF receivers to provide the characteristics and benefits according to the disclosure. FIGS. 9-11 depict process flow diagrams for a method of operating an RF receiver according to an exemplary embodiment.

FIG. 9 illustrates a flow diagram 200. Beginning at 203, the RF receiver, including the demodulator circuit, is powered on. At 206, the demodulator circuitry/detection circuitry are started. At 209, the DSA circuitry is turned on.

At 212, the detection circuitry is turned off (or disabled, etc., as described above). At 215, a timer is enabled. The timer is used for the DSA operation. Timing detection is expected to occur within the time period set in the timer. Otherwise, the demodulator circuitry is restarted.

The timer value is programmable in exemplary embodiments. In some embodiments, the timer value (the time duration) is set to greater than or equal to p preamble time plus s SYNC word time, as discussed above.

At 218, the DSA_detected flag is reset (e.g., to a binary 0 value for an active-low logic circuit). At 221, a check is made whether the output of the correlator exceeds the threshold value. If not, control returns to 218 (i.e., wait for the correlator output signal to exceed the threshold value). If, however, the output of the correlator exceeds the threshold value, control passes to 230 and 260.

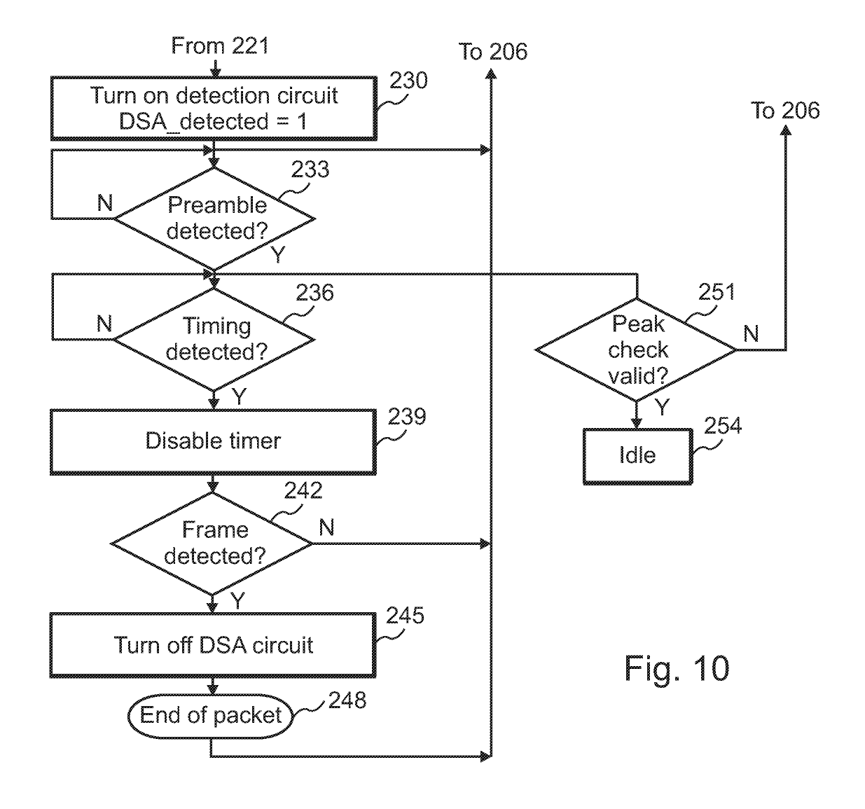

Referring to FIG. 10, at 230, the detection circuitry is turned on. The DSA_detected flag is also set (e.g., to a binary 1 value for an active-low logic circuit). The flag signifies a signal arrival (DSA operation).

At 233, a check is made whether a preamble is detected (the detection circuitry detects preambles). If not, control returns to 233 (i.e., the process waits at 233 for a preamble detection). If, however, a preamble is detected, control passes to 236 and to 251.

At 236, a check is made whether signal timing is detected (the detection circuitry detects proper timing). If not, control returns to 236 (i.e., the process waits at 236 for a timing detection). If, however, proper timing is detected, control passes to 239.

At 251, a check is made (e.g., by the peak check circuit, described above) whether the peak (or peaks) is valid. If so (the DSA correlator peaks are valid), at 254 an idle condition is reached. Otherwise, control returns to 206.

At 239, the timer is disabled to avoid a timeout condition from occurring. At 242, a check is made whether a frame is detected. If not, control returns to 206. Note that the detection of a frame determines whether the DSA circuitry should be kept on or turned off (or disabled, inhibited, etc.). If a frame is detected, then a valid packet is being decoded, in which case the DSA circuitry may be turned of), and control is passed to 245.

At 245, the DSA circuitry is turned off (disabled, inhibited, etc.). At 248, an end of packet condition is registered or reported. Control then passes to 206.

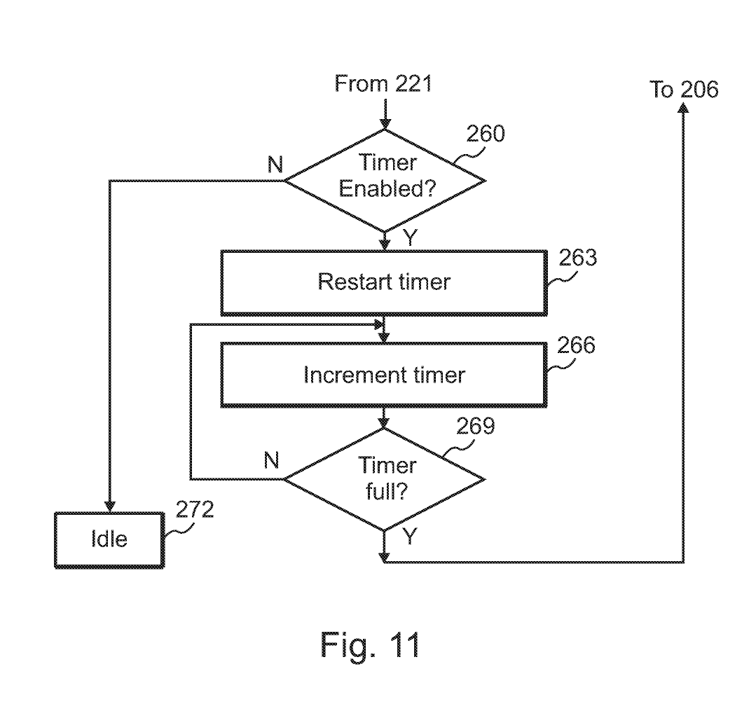

Referring to FIG. 11, at 260, a check is made whether the timer is enabled. If not, at 272 an idle condition is reached. Otherwise, at 263, the timer is restarted.

Subsequently, at 266, the timer is incremented. At 269, a check is made whether the timer is full (e.g., a counter has counted to a terminal value, a desired or prescribed time period has elapsed, etc.). If not, control returns to 266 to increment the timer. Otherwise, control returns to 206 (e.g., a spurious signal or noise has caused a correlation peak).

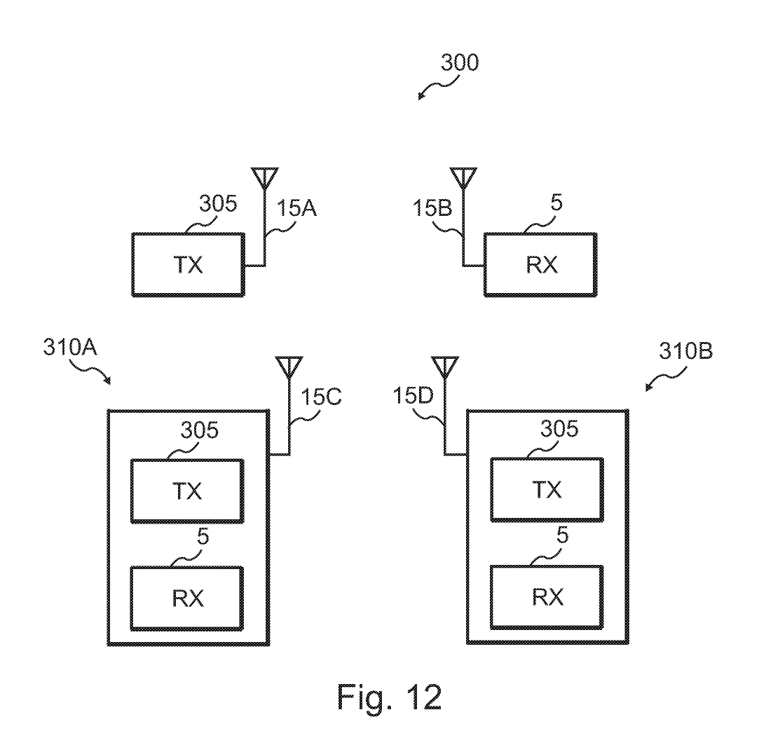

One aspect of the disclosure relates to apparatus that include RF receivers. RF receivers according to exemplary embodiments may be used in a variety of communication arrangements, systems, sub-systems, networks, etc., as desired. FIG. 12 shows a system 300 for radio communication according to an exemplary embodiment.

System 300 includes a transmitter 305, coupled to antenna 15A. Via antenna 15A, transmitter 305 transmits RF signals. The RF signals may be received by receiver 5, described above. In addition, or alternatively, transceiver 310A and/or transceiver 310B might receive (via receiver 5) the transmitted RF signals.

In addition to receive capability, transceiver 310A and transceiver 310B can also transmit RF signals. The transmitted RF signals might be received by receiver 5, either in the stand-alone receiver, or via the receiver circuitry of the non-transmitting transceiver.

Other systems or sub-systems with varying configuration and/or capabilities are also contemplated and possible. For example, in some exemplary embodiments, two or more transceivers (e.g., transceiver 310A and transceiver 310B) might form a network, such as an ad-hoc or mesh network. As another example, in some exemplary embodiments, transceiver 310A and transceiver 310B might form part of a network, for example, in conjunction with transmitter 305, as desired.

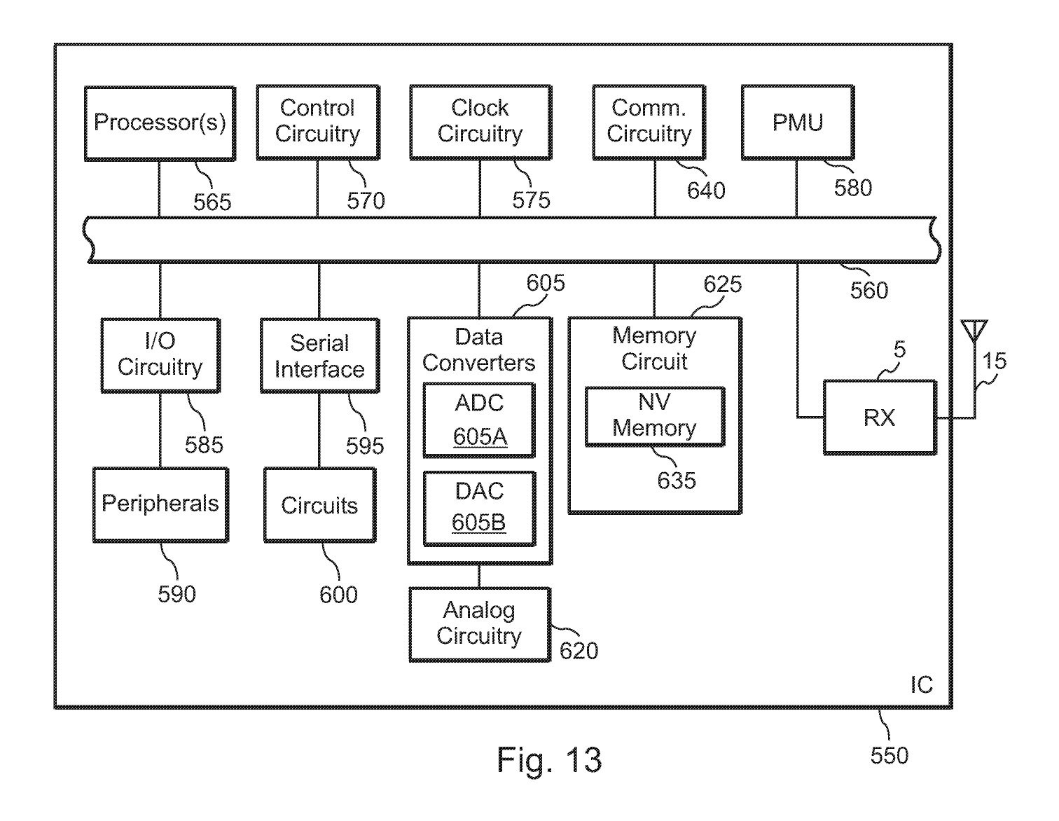

Receivers according to exemplary embodiments may be combined with other circuitry, for example, by integrating the receiver and signal processing, logic, or computing circuitry within an IC. FIG. 13 illustrates an IC 550, for example, a microcontroller unit (MCU), that combines a receiver with other circuit blocks according to an exemplary embodiment. IC 550 includes a number of blocks (e.g., processor(s) 565, data converter 605, I/O circuitry 585, etc.) that communicate with one another using a link 560. In exemplary embodiments, link 560 may constitute a coupling mechanism, such as a bus, a set of conductors or semiconductors for communicating information, such as data, commands, status information, and the like.

IC 550 may include link 560 coupled to one or more processors 565, clock circuitry 575, and power management circuitry 580. In some embodiments, processor(s) 565 may include circuitry or blocks for providing computing functions, such as central-processing units (CPUs), arithmetic-logic units (ALUs), and the like. In some embodiments, in addition, or as an alternative, processor(s) 565 may include one or more digital signal processors (DSPs). The DSPs may provide a variety of signal processing functions, such as arithmetic functions, filtering, delay blocks, and the like, as desired. In some embodiments, functionality of parts of receiver 5, such as those described above, may be implemented or realized using some of the circuitry in processor(s) 565, as desired.

Referring again to FIG. 13, clock circuitry 575 may generate one or more clock signals that facilitate or control the timing of operations of one or more blocks in IC 550. Clock circuitry 575 may also control the timing of operations that use link 560. In some embodiments, clock circuitry 575 may provide one or more clock signals via link 560 to other blocks in IC 550.

In some embodiments, power management circuitry 580 may reduce an apparatus's (e.g., IC 550) clock speed, turn off the clock, reduce power, turn off power, or any combination of the foregoing with respect to part of a circuit or all components of a circuit. Further, power management circuitry 580 may turn on a clock, increase a clock rate, turn on power, increase power, or any combination of the foregoing in response to a transition from an inactive state to an active state (such as when processor(s) 565 make a transition from a low-power or idle or sleep state to a normal operating state).

Link 560 may couple to one or more circuits 600 through serial interface 595. Through serial interface 595, one or more circuits coupled to link 560 may communicate with circuits 600. Circuits 600 may communicate using one or more serial protocols, e.g., SMBUS, I²C, SPI, and the like, as person of ordinary skill in the art will understand.

Link 560 may couple to one or more peripherals 590 through I/O circuitry 585. Through I/O circuitry 585, one or more peripherals 590 may couple to link 560 and may therefore communicate with other blocks coupled to link 560, e.g., processor(s) 365, memory circuit 625, etc.

In exemplary embodiments, peripherals 590 may include a variety of circuitry, blocks, and the like. Examples include I/O devices (keypads, keyboards, speakers, display devices, storage devices, timers, etc.). Note that in some embodiments, some peripherals 590 may be external to IC 550. Examples include keypads, speakers, and the like. In some embodiments, with respect to some peripherals, I/O circuitry 585 may be bypassed. In such embodiments, some peripherals 590 may couple to and communicate with link 560 without using I/O circuitry 585. Note that in some embodiments, such peripherals may be external to IC 550, as described above.

Link 560 may couple to analog circuitry 620 via data converter 605. Data converter 405 may include one or more ADCs 615 and/or one or more DACs 200. The ADC(s) 615 receive analog signal(s) from analog circuitry 620, and convert the analog signal(s) to a digital format, which they communicate to one or more blocks coupled to link 560. Conversely, DAC(s) 200 receive one or more digital signals from one or more blocks coupled to link 560, and convert the digital signal(s) to an analog format. The analog signal(s) may be provided to circuitry within (e.g., analog circuitry 620) or circuitry external to IC 550, as desired. Analog circuitry 620 may include a wide variety of circuitry that provides and/or receives analog signals. Examples include sensors, transducers, and the like, as person of ordinary skill in the art will understand. In some embodiments, analog circuitry 620 may communicate with circuitry external to IC 550 to form more complex systems, sub-systems, control blocks, and information processing blocks, as desired.

Control circuitry 570 couples to link 560. Thus, control circuitry 570 may communicate with and/or control the operation of various blocks coupled to link 560. In addition or as an alternative, control circuitry 570 may facilitate communication or cooperation between various blocks coupled to link 560. In some embodiments, the functionality or circuitry of control circuits in receiver 5 (e.g., controller 45, described above) may be combined with or included with the functionality or circuitry of control circuitry 570, as desired.

Referring again to FIG. 13, in some embodiments, control circuitry 570 may initiate or respond to a reset operation. The reset operation may cause a reset of one or more blocks coupled to link 560, of IC 550, etc., as person of ordinary skill in the art will understand. For example, control circuitry 570 may cause receiver 5 to reset to an initial state. In exemplary embodiments, control circuitry 570 may include a variety of types and blocks of circuitry. In some embodiments, control circuitry 570 may include logic circuitry, FSMs, or other circuitry to perform a variety of operations, such as the operations described above.

Communication circuitry 640 couples to link 560 and also to circuitry or blocks (not shown) external to IC 550. Through communication circuitry 640, various blocks coupled to link 560 (or IC 550, generally) can communicate with the external circuitry or blocks (not shown) via one or more communication protocols. Examples include universal serial bus (USB), Ethernet, and the like. In exemplary embodiments, other communication protocols may be used, depending on factors such as specifications for a given application, as person of ordinary skill in the art will understand.

As noted, memory circuit 625 couples to link 560. Consequently, memory circuit 625 may communicate with one or more blocks coupled to link 560, such as processor(s) 365, control circuitry 570, I/O circuitry 585, etc. In the embodiment shown, memory circuit 625 includes control circuitry 610, memory array 635, and direct memory access (DMA) 630. Control circuitry 610 controls or supervises various operations of memory circuit 625. For example, control circuitry 610 may provide a mechanism to perform memory read or write operations via link 360. In exemplary embodiments, control circuitry 610 may support various protocols, such as double data rate (DDR), DDR2, DDR3, and the like, as desired. In some embodiments, the memory read and/or write operations involve the use of one or more blocks in IC 550, such as processor(s) 565. DMA 630 allows increased performance of memory operations in some situations. More specifically, DMA 630 provides a mechanism for performing memory read and write operations directly between the source or destination of the data and memory circuit 625, rather than through blocks such as processor(s) 565.

Memory array 635 may include a variety of memory circuits or blocks. In the embodiment shown, memory array 635 includes volatile memory 635A and non-volatile (NV) memory 635B. In some embodiments, memory array 635 may include volatile memory 635A. In some embodiments, memory array 635 may include NV memory 635B. NV memory 635B may be used for storing information related to performance or configuration of one or more blocks in IC 550. For example, NV memory 635B may store configuration information related to various operations of receiver 5 and/or to initial or ongoing configuration or control of receiver 5, as desired.

As described above in detail, receiver 5 receives RF signals via antenna 15, and processes those signals. The resulting data signals are provided to one or more blocks of circuitry in IC 550 via link 560. Furthermore, various blocks of circuitry in IC 550 may be used to process the received data and to generate additional data or signals, which may be used to control other circuitry, etc.

In some embodiments, a transmitter may be included in IC 550. In such configurations, the transmitter may transmit information generated or processed in IC 550, such as information derived from, based on, or related to data received by receiver 5. Thus, sophisticated control and communication subsystems, blocks, circuits, or systems for processing information and/or control may be implemented.

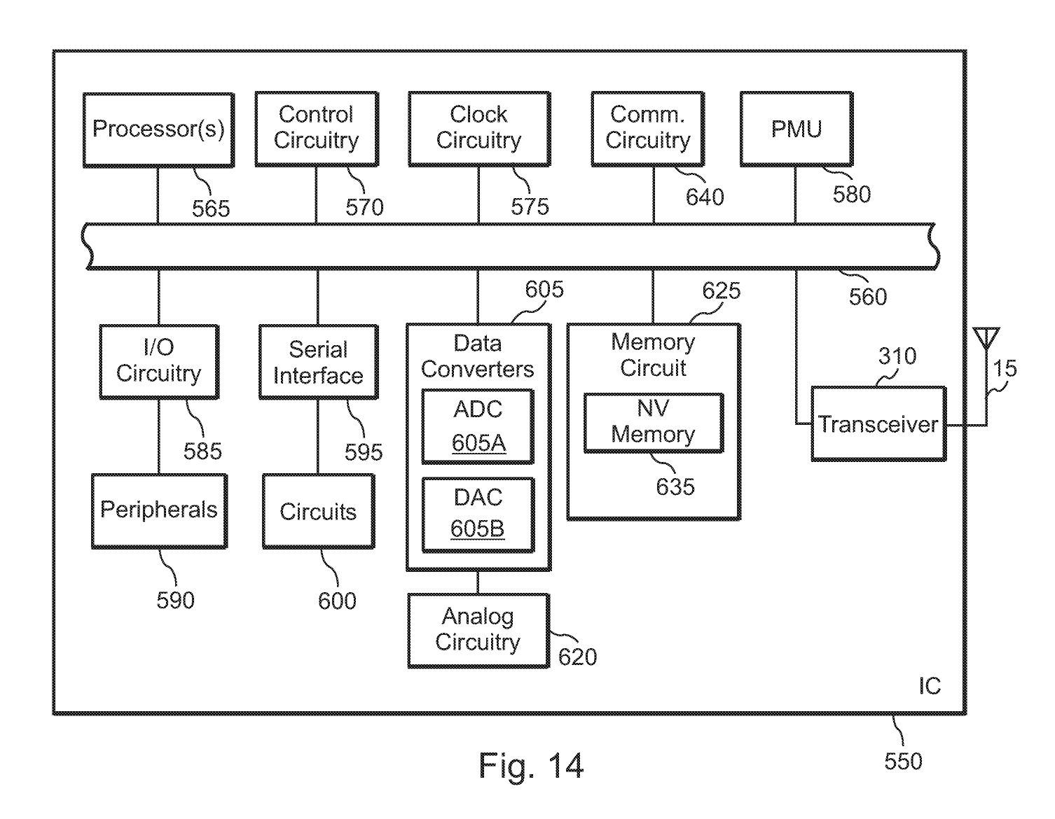

FIG. 14 shows a circuit arrangements for an IC 550 according to another exemplary embodiment. Unlike IC 550 in FIG. 13, IC 550 in FIG. 14 has both RF receive and transmit capability. More specifically, IC 550 in FIG. 14 includes one or more transceivers 310. Transceiver(s) 310, which include respective RF receiver(s) 5, transmit and/or receive RF signals via antenna 15, as described above. Transceiver(s) 310 are coupled to link 560, as described above with respect to receiver 5, to provide communication and cooperation with various blocks in IC 550, as desired, and as described above.

Various circuits and blocks described above and used in exemplary embodiments may be implemented in a variety of ways and using a variety of circuit elements or blocks. For example, the demodulator circuitry, the DSA circuitry and the detection circuitry may generally be implemented using digital circuitry. The digital circuitry may include circuit elements or blocks such as gates, digital multiplexers (MUXs), latches, flip-flops, registers, finite state machines (FSMs), processors, programmable logic (e.g., field programmable gate arrays (FPGAs) or other types of programmable logic), arithmetic-logic units (ALUs), standard cells, custom cells, etc., as desired, and as persons of ordinary skill in the art will understand.

In addition, analog circuitry or mixed-signal circuitry or both may be included, for instance, power converters, discrete devices (transistors, capacitors, resistors, inductors, diodes, etc.), and the like, as desired. The analog circuitry may include bias circuits, decoupling circuits, coupling circuits, supply circuits, current mirrors, current and/or voltage sources, filters, amplifiers, converters, signal processing circuits (e.g., multipliers), detectors, transducers, discrete components (transistors, diodes, resistors, capacitors, inductors), analog MUXs and the like, as desired, and as persons of ordinary skill in the art will understand.

The mixed-signal circuitry may include analog to digital converters (ADCs), digital to analog converters (DACs), etc.) in addition to analog circuitry and digital circuitry, as described above, and as persons of ordinary skill in the art will understand. The choice of circuitry for a given implementation depends on a variety of factors, as persons of ordinary skill in the art will understand. Such factors include design specifications, performance specifications, cost, IC or device area, available technology, such as semiconductor fabrication technology), target markets, target end-users, etc.

Referring to the figures, persons of ordinary skill in the art will note that the various blocks shown might depict mainly the conceptual functions and signal flow. The actual circuit implementation might or might not contain separately identifiable hardware for the various functional blocks and might or might not use the particular circuitry shown. For example, one may combine the functionality of various blocks into one circuit block, as desired. Furthermore, one may realize the functionality of a single block in several circuit blocks, as desired. The choice of circuit implementation depends on various factors, such as particular design and performance specifications for a given implementation. Other modifications and alternative embodiments in addition to the embodiments in the disclosure will be apparent to persons of ordinary skill in the art. Accordingly, the disclosure teaches those skilled in the art the manner of carrying out the disclosed concepts according to exemplary embodiments, and is to be construed as illustrative only. Where applicable, the figures might or might not be drawn to scale, as persons of ordinary skill in the art will understand.

The particular forms and embodiments shown and described constitute merely exemplary embodiments. Persons skilled in the art may make various changes in the shape, size and arrangement of parts without departing from the scope of the disclosure. For example, persons skilled in the art may substitute equivalent elements for the elements illustrated and described. Moreover, persons skilled in the art may use certain features of the disclosed concepts independently of the use of other features, without departing from the scope of the disclosure.

1. An apparatus, comprising:
a radio-frequency (RF) receiver, comprising
digital signal arrival (DSA) circuitry to detect an arrival of a received signal in the RF receiver and to indicate arrival of the received signal;
detection circuitry to detect a signal from the received signal; and
a controller to control operation of the detection circuitry depending on whether the DSA circuitry indicates the arrival of the received signal.

2. The apparatus according to claim 1, wherein the DSA circuitry operates on a subset of a set of bits comprising the received signal.

3. The apparatus according to claim 2, wherein the RF receiver further comprises a digital automatic gain control (AGC) circuit to select and provide the subset of bits to the DSA circuitry.

4. The apparatus according to claim 3, the RF receiver further comprises a channel filter coupled to the digital AGC circuit, and wherein the digital AGC circuit selects the subset of bits based on detecting a power of the received signal in the channel filter.

5. The apparatus according to claim 3, wherein the DSA circuitry comprises:
a complex multiplier coupled to the digital AGC circuit; and
a divider circuit coupled to the complex multiplier.

6. The apparatus according to claim 2, wherein the DSA circuitry comprises a correlator to operate on the subset of bits and to provide a correlator output signal.

7. The apparatus according to claim 6, wherein the DSA circuitry further comprises a comparator to compare a dynamic threshold value with a signal derived from the correlator output signal to determine arrival of the received signal.

8. The apparatus according to claim 7, wherein the DSA circuitry further comprises a peak check circuit coupled to receive an output of the comparator and to prevent false indication of the arrival of the received signal because of spurious signals.

9. The apparatus according to claim 1, wherein the controller controls the operation of the detection circuitry by selectively: (a) interrupting power to the detection circuitry; (b) inhibiting a clock signal of the detection circuitry; or (c) disabling the detection circuitry.

10. An integrated circuit (IC), comprising:
a radio-frequency (RF) receiver, comprising:
digital signal arrival (DSA) circuitry comprising a correlator to operate on a subset of bits of a set of bits comprising a received signal in the RF receiver to reduce a power consumption of the correlator, the DSA circuitry to provide a signal indicating arrival of the received signal;
a controller to control operation of a detection circuitry depending on whether the DSA circuitry indicates the arrival of the received signal.

11. The IC according to claim 10, further comprising a digital automatic gain control (AGC) circuit to provide the subset of bits to the DSA circuitry.

12. The IC according to claim 10, wherein the DSA circuitry provides a signal indicating arrival of the received signal depending on whether an output signal of the correlator exceeds a dynamic threshold value.

13. The IC according to claim 10, wherein the DSA circuitry comprises a peak check circuit to check peaks of the output signal of the correlator to prevent false indication of the arrival of the received signal

14. The apparatus according to claim 10, wherein the received signal in the RF receiver is modulated according to IEEE 802.15.4 standard.

15. A method of processing signals in a radio-frequency (RF) receiver, the method comprising:
detecting arrival of a signal received in the RF receiver by using digital signal arrival (DSA) circuitry, and to indicate arrival of the received signal; and
selectively detecting a signal from the received signal depending on indication by the DSA circuitry of the arrival of the received signal.

16. The method according to claim 15, wherein detecting arrival of the signal received in the RF receiver further comprises using a subset of a set of bits comprising the received signal.

17. The method according to claim 16, wherein detecting arrival of the signal received in the RF receiver further comprises using a correlator to operate on the subset of bits in order to reduce a power consumption of the correlator.

18. The method according to claim 17, wherein detecting arrival of the signal received in the RF receiver further comprises:
comparing an output signal of the correlator with a dynamic threshold value; and
checking peaks in the output signal of the correlator to prevent false indication of the arrival of the received signal.

19. The method according to claim 15, selectively detecting a signal from the received signal further comprises selectively operating a detection circuitry.

20. The method according to claim 19, wherein selectively operating the detection circuitry further comprises: (a) interrupting power to the detection circuitry; (b) inhibiting a clock signal of the detection circuitry; or (c) disabling the detection circuitry.
